(19) United States
(12) Patent Application Publication
(10) Pub. No.: US 2010/0012835 A1
(43) Pub. Date: Jan. 21, 2010

(54) MS/MS MASS SPECTROMETER

(75) Inventors: Daisuke Okumura, Kyoto-shi (JP); Hiroto Itoi, Kyoto-shi (JP); Kazuo Mukaibatake, Kyoto-shi (JP); Kazuo Miyoshi, Hachioji-shi (JP)

Correspondence Address: SUGHRUE MION, PLLC, 2100 PENNSYLVANIA AVENUE, N.W., SUITE 800, WASHINGTON, DC, 20037, US

(73) Assignee: Shimadzu Corporation, Nakagyo-ku, Kyoto (JP)

(21) Appl. No.: 12/444,509

(22) PCT Filed: Oct. 11, 2006
(86) PCT No.: PCT/JP2006/320290

§ 371 Date: Apr. 6, 2009

(51) Int. Cl. H01J 49/26; B01D 59/44

(52) U.S. Cl. 250/288

(57) ABSTRACT

The inside of the collision cell 20 placed in the analysis chamber 10 which is vacuum-evacuated is partitioned into an anterior chamber 23 and a posterior chamber 24 by the partition wall 21 with a communicating aperture 22. The former is used as a dissociation area A1 and the latter as a convergence area A2. Electrodes 27 and 28 for forming a radio-frequency electric field are placed in the chambers 23 and 24, respectively. When a CID gas is supplied into the anterior chamber 23, the CID gas is dispersed inside the anterior chamber 23 and flows into the analysis chamber 10 via the posterior chamber 24. Consequently, the gas pressure in the posterior chamber becomes higher than the gas pressure in the analysis chamber 10, and the gas pressure in the anterior chamber 23 becomes higher than the gas pressure in the posterior chamber 24. Hence, the optimum gas pressure for the precursor ion's dissociation and the ions' convergence by a cooling process can be realized in each of the dissociation area A1 and the convergence area A2. Therefore, it is possible to increase both the efficiency of dissociation and the efficiency of the ion convergence.

### TECHNICAL FIELD

The present invention relates to an MS/MS spectrometer for dissociating an ion having a specific mass-to-charge ratio (m/z) by a collision-induced dissociation (CID) and mass analyzing the product ion (or fragment ion) generated by this process.

### BACKGROUND ART

A well-known mass analyzing method for identifying a substance having a large molecular weight and for analyzing its structure is an MS/MS analysis (which is also called a tandem analysis). FIG. 12 is a schematic configuration diagram of a conventional MS/MS mass spectrometer disclosed in Patent Documents 1 and 2 or other documents.

In this MS/MS mass spectrometer, three-stage quadrupoles 12, 13, and 15 each composed of four rod electrodes are provided, inside the analysis chamber 10 which is vacuum-evacuated by a vacuum pump which is not shown, between an ion source 11 for ionizing a sample to be analyzed and a detector 16 for ultimately detecting an ion and providing a detection signal in accordance with the amount of ions. A voltage ±(U1+V1·cos ωt) is applied to the first-stage quadrupole 12, in which a direct current U1 and a radio-frequency voltage V1·cos ωt are synthesized. Due to the action of the electric field generated by this application, only a target ion having a specific mass-to-charge ratio is selected as a precursor ion from among a variety of ions generated in the ion source 11 and allowed to pass through the first-stage quadrupole 12.

The second-stage quadrupole 13 is placed in the well-sealed collision cell (or collision chamber) 14, and Ar gas for example as a CID gas is introduced into the collision cell 14. The precursor ion sent from the first-stage quadrupole 12 collides with Ar gas inside the collision cell 14 and is dissociated by the collision-induced dissociation to produce a product ion. Since this dissociation has a variety of modes, two or more kinds of product ions with different mass-to-charge ratios are generally produced from one kind of precursor ion, and these product ions exit from the collision cell 14 and are introduced into the third-stage quadrupole 15. Since not every precursor ion is dissociated, some precursor ions may be directly sent into the third-stage quadrupole 15.

To the third-stage quadrupole 15, a voltage ±(U3+V3·cos ωt) is applied in which a direct current U3 and a radio-frequency voltage V3·cos ωt are synthesized. Due to the action of the electric field generated by this application, only a product ion having a specific mass-to-charge ratio is selected, passes through the third-stage quadrupole 15, and reaches the detector 16. The direct current U3 and radio-frequency voltage V3·cos ωt which are applied to the third-stage quadrupole 15 are appropriately changed, so that the mass-to-charge ratio of an ion capable of passing the third-stage quadrupole electrodes 15 is scanned to obtain the mass spectrum of the product ions generated by the dissociation of the target ion.

In the aforementioned configuration, the collision cell 14 has the function to make a precursor ion collide with a CID gas in order to promote the dissociation. The collision cell 14 also has the function for making ions having a large kinetic energy touch a CID gas to decay the kinetic energy, i.e. the function for cooling the ions, and efficiently transporting them into the subsequent stage while preventing a dispersion. In this case, the CID gas performs as a cooling gas. In other words, the collision cell 14 has both the function of a CID and the function of a convergence by a cooling process. In practice, however, the conditions of the gas pressure appropriate for achieving the two functions are not the same. Nonetheless, in a conventional MS/MS mass spectrometer, the gas pressure is set to be an appropriate value which can substantially satisfy the two aforementioned functions in order to achieve both functions in the collision cell 14. Since the tendency of the CID among other characteristics depends on the length of the collision cell 14 in the ion's passage direction (generally in the direction along the ion optical axis C), the size of the collision cell 14 is designed so that a certain level of sufficient CID and cooling can be performed under the set gas pressure. Specifically speaking, in a conventional and general MS/MS mass spectrometer, the length of the collision cell 14 in the direction along the ion optical axis C is set to be approximately 150 through 200 mm, and the supply of the CID gas is controlled so that the gas pressure in the collision cell 14 should be a few mTorr.

[Patent Document 1] Japanese Unexamined Patent Application Publication No. H07-201304

[Patent Document 2] Japanese Unexamined Patent Application Publication No. H08-124519

### DISCLOSURE OF THE INVENTION

### Problems to be Solved by the Invention

As previously described, the gas pressure in the collision cell 14 is not always optimum for the CID and ion convergence by cooling. Therefore, the efficiency of the dissociation and the efficiency of the ion convergence are not optimal. This is one of the causes that prevents the improvement of the detection sensitivity. In addition, in a conventional configuration, the collision cell 14 is long in the direction along the ion optical axis C in order to compensate for the fact that the gas pressure cannot be increased to the optimum value for the CID, for the purpose of sufficiently performing the CID. This makes it difficult to downsize the entire apparatus.

The present invention has been produced in view of such problems, and the objective thereof is to provide an MS/MS mass spectrometer capable of improving the efficiency of the precursor ion's dissociation and the efficiency of the ion convergence by cooling more than before, and having a downsized collision cell to be advantageous in downsizing the entire apparatus.

### Means for Solving the Problems

The present invention developed to solve the aforementioned problems provides an MS/MS mass spectrometer in which a first mass separation unit for selecting an ion having a specific mass-to-charge ratio as a precursor ion from among a variety of ions, a dissociation/convergence unit for making the precursor ion collide with a predetermined gas provided from outside in order to dissociate the precursor ion by a collision-induced dissociation and converging ions by a cooling action due to a collision with the predetermined gas, and a second mass separation unit for selecting an ion having a specific mass-to-charge ratio from among a variety of product ions generated by a dissociation of the precursor ion, are disposed inside an analysis chamber which is vacuum-evacuated, wherein the dissociation/convergence unit independently comprises:

a dissociation area, in which a gas pressure is maintained higher than a gas pressure in the analysis chamber by the predetermined gas, for dissociating the precursor ion; and

a convergence area, in which a gas pressure is maintained higher than the gas pressure in the analysis chamber by the predetermined gas, for cooling ions sent from the dissociation area to converge the ions.

Conventionally, the dissociation of a precursor ion and the cooling of ions have been performed in a single area inside a collision cell. On the other hand, the MS/MS mass spectrometer according to the present invention has two spatially separated areas for the dissociation and cooling: the dissociation area for promoting the dissociation by the CID, and the convergence area for cooling the product ions generated by the dissociation, the precursor ion which has passed through the dissociation area without being dissociated, and other ions in order to converge them. The gas pressure (or degree of vacuum) in each area is set to be the optimum or almost optimum condition for the CID and cooling.

As an embodiment of spatially separating the dissociation area and the convergence area as just described, the inside of a collision cell, which is substantially hermetically-closed, having an ion injection aperture and an ion exit aperture may be partitioned into an anterior chamber and a posterior chamber by a partition wall having a communicating aperture; the predetermined gas may be supplied from outside into the anterior chamber or the posterior chamber; and the dissociation area may be provided in the anterior chamber and the convergence area is provided in the posterior chamber.

In this configuration, after the predetermined gas such as Ar gas which is supplied into the anterior chamber for example from the outside of the analysis chamber is substantially dispersed in the anterior chamber, the predetermined gas flows out into the posterior chamber via the communicating aperture. Then after the predetermined gas is substantially dispersed in the posterior chamber, it flows out into the analysis chamber via the ion exit aperture. A portion of the predetermined gas supplied into the anterior chamber directly flows into the analysis chamber via the ion injection aperture. Since the inside of the analysis chamber is vacuum-evacuated, the predetermined gas which flowed into the analysis chamber is promptly evacuated. In this case, the gas pressure condition can be easily attained in which the gas pressure in the posterior chamber is higher than that in the analysis chamber and the gas pressure in the anterior chamber is still higher than that in the posterior chamber. In the case where the predetermined gas is supplied into the posterior chamber from the outside of the analysis chamber, the gas pressure condition can be easily attained in which the gas pressure in the anterior chamber is higher than that in the analysis chamber and the gas pressure in the posterior chamber is sill higher than that in the anterior chamber.

The appropriate determination of the following values can allow the gas pressures in the anterior chamber and posterior chamber to be freely set to some extent: each volume of the anterior chamber and posterior chamber, the opening spaces of the ion injection aperture, ion exit aperture, and communicating aperture, the flow rate of the predetermined gas, and other factors. Therefore, this makes it easy to attain both the optimum condition of the gas pressure for the ion's dissociation by the CID in the dissociation area, and the optimum condition of the gas pressure for the ions' convergence by the cooling in the convergence area.

In each of the dissociation area and the convergence area, an electrode for forming at least a radio-frequency electric field (usually, a direct-current electric field as well) is disposed. However, it is preferable that an electrode to which a voltage can be independently applied may be provided in the dissociation area and the convergence area. Since this makes it possible to form a different and appropriate electric field in the dissociation area and the convergence area, the ions necessary for the analysis can be effectively used without being dispersed, which further improves the detection sensitivity.

### EFFECTS OF THE INVENTION

In the MS/MS mass spectrometer according to the present invention, the efficiency of the precursor ion's dissociation improves, so that the amount of the generated product ions is increased. In addition, since the product ions are maximally converged and transported to the second mass separator such as a quadrupole mass filter, the amount of ions which finally reach the detector increases. This improves the detection sensitivity and facilitates the determination and structural analysis of a sample. Furthermore, since a high gas pressure can be set in the dissociation area without respect to the ions' convergence condition due to the cooling, the length of the area along the ion optical axis can be shortened in exchange for the increase of the gas pressure. This brings about the unprecedented downsizing of the entire dissociation/convergence unit, and is also advantageous in downsizing the mass spectrometer itself.

### BRIEF DESCRIPTION OF THE DRAWINGS

FIG. 1 is an overall configuration diagram of an MS/MS mass spectrometer according to one embodiment (the first embodiment) of the present invention.

FIG. 2 is a detailed sectional view of a dissociation/convergence unit in the MS/MS mass spectrometer of the first embodiment.

FIG. 3(a) is a perspective view of electrodes disposed in the anterior chamber in the MS/MS mass spectrometer of the first embodiment, and FIG. 3(b) illustrates a schematic layout of the same electrodes on a plane orthogonal to the ion optical axis C.

FIG. 4 is a detailed sectional view of a dissociation/convergence unit in the MS/MS mass spectrometer of another embodiment (the second embodiment) of the present invention.

FIG. 5 is a diagram illustrating another embodiment of the electrodes used for the dissociation/convergence unit.

FIG. 6 is a diagram illustrating another embodiment of the electrodes used for the dissociation/convergence unit.

FIG. 7 is a diagram illustrating another embodiment of the electrodes used for the dissociation/convergence unit.

FIG. 8 is a diagram illustrating another embodiment of the electrodes used for the dissociation/convergence unit.

FIG. 9 is a diagram illustrating another embodiment of the electrodes used for the dissociation/convergence unit.

FIG. 10 is a diagram illustrating another embodiment of the electrodes used for the dissociation/convergence unit.

FIG. 11 is a detailed sectional view of a dissociation/convergence unit in the MS/MS mass spectrometer of another embodiment.

FIG. 12 is an overall configuration diagram of a conventional MS/MS mass spectrometer.

### EXPLANATION OF NUMERALS

10 . . . . Analysis Chamber
11 . . . . Ion Source
12 . . . . First-Stage Quadrupole
15 . . . . Third-Stage Quadrupole
16 . . . . Detector
20 . . . . Collision Cell
21 . . . . Partition Wall
22 . . . . Communicating Aperture
23 . . . . Anterior Chamber
24 . . . . Posterior Chamber
25 . . . . Ion Injection Aperture
26 . . . . Ion Exit Aperture
30 . . . CID Gas Supplier
31 . . . . Valve
32 through 35 . . . RF+DC Voltage Generator
36 . . . . Controller
C . . . . Ion Optical Axis

### BEST MODES FOR CARRYING OUT THE INVENTION

### First Embodiment

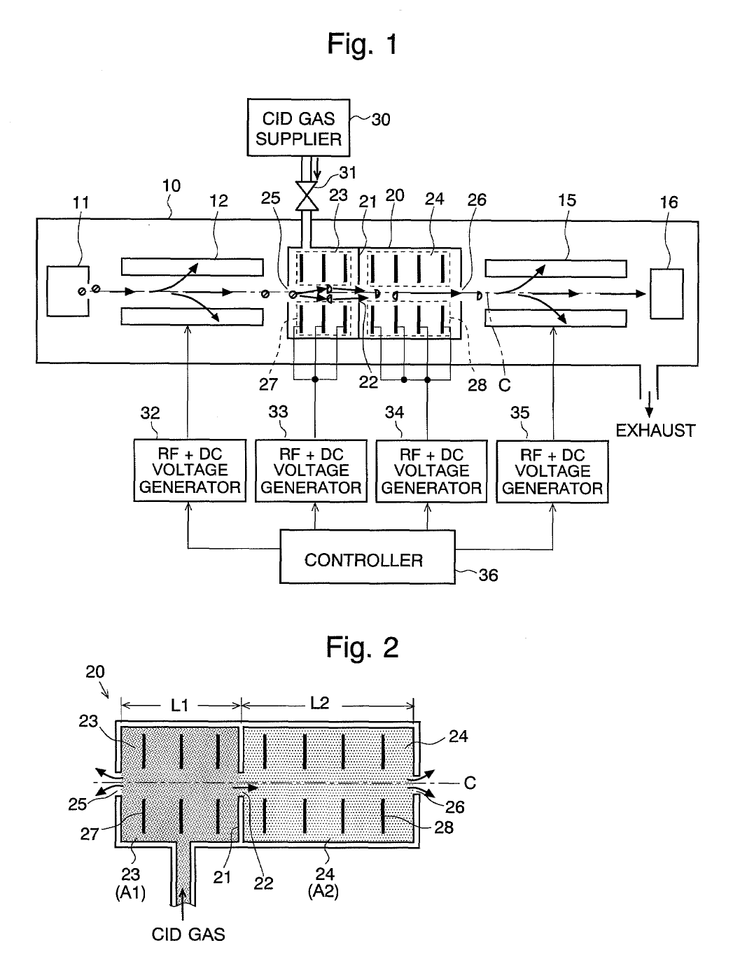

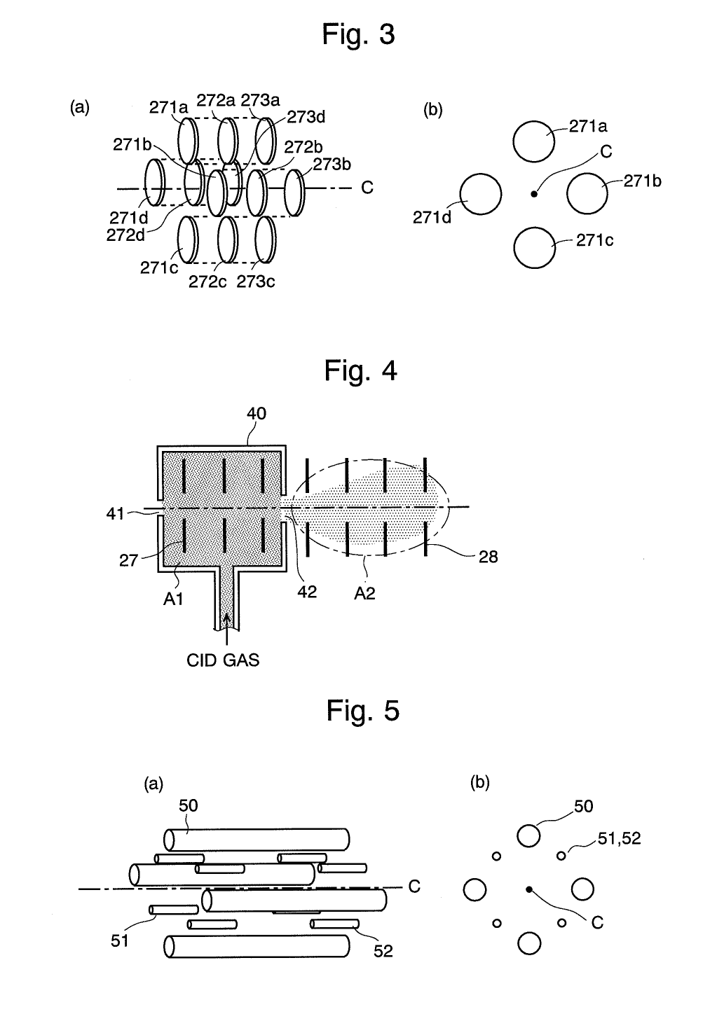

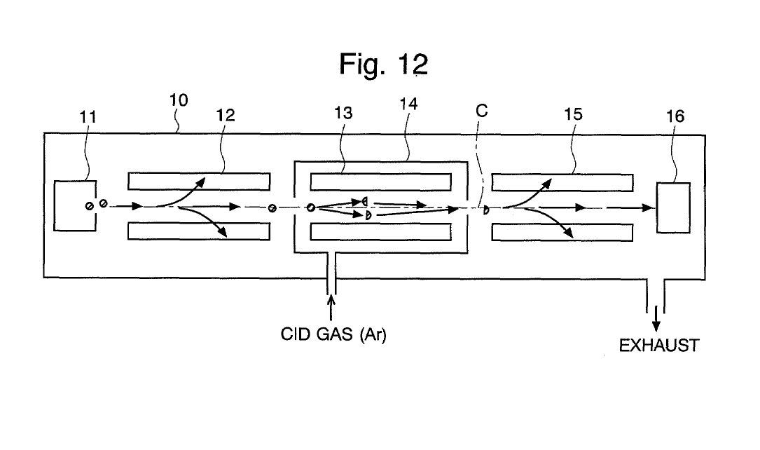

An MS/MS mass spectrometer which is an embodiment (or the first embodiment) of the present invention will be described with reference to the figures. FIG. 1 is an overall configuration diagram of the MS/MS mass spectrometer according to the first embodiment, and FIG. 2 is a detailed sectional view of a dissociation/convergence unit. FIG. 3(a) is a perspective view of the electrodes disposed in the anterior chamber of a collision cell, and FIG. 3(b) illustrates a schematic layout of the same electrodes on a plane orthogonal to the ion optical axis C. The same components as in the conventional configuration as illustrated in FIG. 12 are indicated with the same numerals and the detailed explanations are omitted.

In the MS/MS mass spectrometer of the first embodiment, a collision cell 20, whose structure is different from that of the conventional collision cell 14 illustrated in FIG. 12, is provided between the first-stage quadrupole 12 (which correspond to the first mass separator in the present invention) and the third-stage quadrupole 15 (which correspond to the second mass separator in the present invention). The collision cell 20 functions as the dissociation/convergence unit in the present invention. The inside of the collision cell 20 is partitioned by a partition wall 21, which has a communicating aperture 22 for an ion passage in the center, into an anterior chamber 23 and posterior chamber 24. The inside the anterior chamber 23 is a dissociation area A1, and the inside of the posterior 24 is a convergence area A2.

In the anterior chamber 23, as illustrated in FIG. 3, electrodes 27 are placed in the following manner: four disk electrodes having the same diameter 271a, 271b, 271c, and 271d are disposed to surround the ion optical axis C in a plane orthogonal to the ion optical axis C. In addition, considering the four electrodes 271a, 271b, 271c, and 271d as a single group, the group is translated in the direction along the ion optical axis C so that a plurality (three in this example) of groups are sterically arranged at predetermined intervals. Also in the posterior chamber 24, electrodes 28 having the same configuration are disposed. However, the number of electrodes arranged in the direction along the ion optical axis C is different (or may be the same) from the number of the electrodes 27. These electrodes 27 and 28 are a substitute for the rod electrodes of the second quadruple 13 in the configuration of FIG. 12.

To the first quadrupole 12, the RF+DC voltage generator 32 applies a voltage ±(U1+V1·cos ωt) in which a direct current voltage U1 and a radio-frequency voltage V1·cos ωt are synthesized or a voltage in which a predetermined direct current bias voltage is further added. To the third quadrupole 15, the RF+DC voltage generator 35 applies a voltage ±(U3+V3·cos ωt) in which a direct current voltage U3 and a radio-frequency voltage V3·cos ωt are synthesized, or a voltage in which a predetermined direct current bias voltage is further added. These voltage settings are performed in the same manner as before. To the electrodes 27 which are placed in the anterior chamber 23, the RF+DC voltage generator 33 applies a voltage in which a direct current bias voltage and a radio-frequency voltage are synthesized. To the electrodes 28 which are placed in the posterior chamber 24, the RF+DC voltage generator 34 applies a voltage in which a direct current bias voltage and a radio-frequency voltage are synthesized. The voltages generated in the RF+DC voltage generators 32, 33, 34, and 35 are controlled by the controller 36.

Concretely speaking, in the four electrode plates 271a through 271d illustrated in FIG. 3(b) for example, two electrode plates facing across the ion optical axis C, i.e. 271a and 271c, and 271b and 271d, are respectively connected, and a radio-frequency voltage having a different polarity from each other is applied to the adjacent electrode plate in the circumferential direction. The direct current bias voltage is appropriately determined in accordance with the values of the direct current bias voltages applied to the first quadrupole 12 and the third quadrupole 15 or other factors. However, although the same voltage is applied to the electrodes arranged in the direction along the ion optical axis (e.g. 271a, 272a, 273a) in the configuration of FIG. 1, the direct current bias voltage may be changed along the ion optical axis C in a stepwise fashion in order to form a direct current electric field to accelerate an ion. These voltage settings are performed in the same manner also in the anterior chamber 23 and posterior chamber 24. Basically, the radio-frequency electric field formed by the radio-frequency voltage applied to each of the electrodes 27 and 28 converges ions passing through the radio-frequency electric field to bring them closer to the ion optical axis C.

Ar gas which functions as a CID gas or cooling gas is supplied into the anterior chamber 23 of the collision cell 20 via a valve 31 from a CID gas supplier 30. The anterior chamber 23 is hermetically closed aside from the ion injection aperture 25 and the communicating aperture 22. Since the inside of the analysis chamber 10 is vacuum-evacuated and maintained at a low gas pressure (or high degree of vacuum), the Ar gas supplied into the anterior chamber 23 leaks into the analysis chamber 10 via the ion injection aperture 25 and simultaneously leaks into the posterior chamber 24 via the communicating aperture 22. Aside from the communicating aperture 22, the posterior chamber 24 is basically hermetically closed other than the ion exit aperture 26. Therefore, the Ar gas supplied into the posterior chamber 24 leaks into the analysis chamber 10 via the ion exit aperture 26. The volume of the inside of the analysis chamber 10 is dramatically larger compared to that of the anterior chamber 23 and posterior chamber 24, and the analysis chamber 10 is promptly vacuum-evacuated. Therefore, due to the current of the Ar gas as previously described, the relationship among the gas pressure P1 in the anterior chamber 23, the gas pressure P2 in the posterior chamber 24, and the gas pressure P3 in the analysis chamber 10 becomes P1>P2>P3.

The gas pressure P3 is substantially determined by the capacity of the vacuum pump for vacuum-evacuating the analysis chamber 10. The gas pressures P1 and P2 are determined by the supply flow rate of the Ar gas, each volume of the anterior chamber 23 and posterior chamber 24, the areas of the ion injection aperture 25, ion exit aperture 26, and communicating aperture 22, and other factors. The gas pressures P1 and P2 can be freely determined to some extent by such structural designs and the setting for the control. At this point in time, as an example, suppose that the length L1 of the anterior chamber 23 in the direction along the ion optical axis C is 30 mm and the gas pressure P1 in the anterior chamber 23 is set to be 5 mTorr, and the length L2 of the posterior chamber 24 in the direction along the ion optical axis C is 50 mm and the gas pressure P2 in the posterior chamber 24 is set to be 2 mTorr. However, it should be noted that these values are not limited to these, and can be appropriately changed.

The characteristic operation of the MS/MS mass spectrometer having the aforementioned configuration will be explained. Among a variety of ions exiting from the ion source 11, an ion having a specific mass-to-charge ratio is selected as a precursor ion in the first quadrupole 12 and introduced into the anterior chamber 23 through the ion injection aperture 25. Since the gas pressure inside the anterior chamber 23 is relatively high as previously described and the density of Ar gas is high, the precursor ion introduced into the anterior chamber 23 collides with the Ar gas with high probability. Consequently, the dissociation of the precursor ion is promoted with high efficiency, and a variety of product ions are created in accordance with the mode of dissociation. Due to the action of the radio-frequency electric field formed by the radio-frequency voltage applied to the electrodes 27 in the anterior chamber 23, the variety of product ions created by the dissociation converge in the vicinity of the ion optical axis C without being dispersed, and sent into the posterior chamber 24 through the communicating aperture 22.

In the posterior chamber 24, the Ar gas exists in relatively high density although lower than in the anterior chamber 23. Hence, the product ions sent into the posterior chamber 24 touch the Ar gas with high probability and the kinetic energy that the ions have attenuates. That is, cooling is performed for the product ions and the precursor ions which have passed through the anterior chamber 23 without being dissociated, and the ions after the cooling become more susceptible to the action of the radio-frequency electric field formed by the radio-frequency voltage applied to the electrodes 28 in the posterior chamber 24. Accordingly, most of the ions introduced into the posterior chamber 24 do not disperse but effectively converge in the vicinity of the ion optical axis C, and are drawn out through the ion exit aperture 26 to be sent into the third quadrupole 15. Therefore, it is possible to make the most of the product ions created by the dissociation and make them to be mass analyzed. In the third quadrupole 15, among the variety of product ions which have been sent in, an ion having a specific mass-to-charge ratio is selected, and reaches the detector 16 to be detected.

As just described, with the MS/MS mass spectrometer according to the present embodiment, in the anterior chamber 23 and posterior chamber 24 which are separated from each other in the collision cell 20, the ion's dissociation and the ions' convergence by a cooling process can be independently realized under the optimum or nearly optimum condition of the gas pressure for each. In addition to the gas pressure, since the electrodes 27 and 28 are also separated, the voltages to be applied to these electrodes can be set to the values appropriate for the ion's dissociation and the ions' convergence by the cooling, respectively. Therefore, compared to the conventional case where the ion's dissociation and the ions' convergence by cooling are preformed in the same space, the efficiency of the dissociation can be enhanced to increase the amount of the production of the product ions, and simultaneously, it is possible to make the most of the created product ions to be transported into the subsequent stage in order to be mass analyzed. Since this increases the detection sensitivity of the product ions, the peaks appearing on the mass spectrum become higher for example, which facilitates the identification of the sample and the analysis of the structure.

In the aforementioned explanation, the gas pressure in the anterior chamber 23 is set to be higher than the gas pressure in the posterior chamber 24. However, the high-low relationship of the gas pressure can be reversed by introducing the CID gas into the posterior chamber 24.

### Second Embodiment

An MS/MS mass spectrometer which is another embodiment (or the second embodiment) of the present invention will be described with reference to the figures. The mass spectrometer in the second embodiment is almost the same as that in the first embodiment and only the dissociation/convergence unit's configuration is different. This configuration will be described with reference to FIG. 4.

As illustrated in FIG. 4, the dissociation area A1 is the inside of the collision cell 40 whose length L1 is almost the same as that of the anterior chamber 23 in the first embodiment. The convergence area A2 is formed outside and near the ion exit aperture 42 formed in the collision cell 40, and provided in the same space as the analysis chamber 10. The CID gas is supplied into the collision cell 40, which maintains the gas pressure in the collision cell 40 at P1. The CID gas is spouted into the analysis chamber 10 from the ion exit aperture 42, forming an area surrounded by the electrodes 28 in which the gas pressure (gas pressure P2) is higher than in the surrounding area. The former area functions as the convergence area A2. Since the CID gas is spouted into the analysis chamber 10 from the ion injection aperture 41 as well, it is preferable that the area of the ion exit aperture 42 be larger than the area of the ion injection aperture 41 or another configuration may be taken so that a larger amount of CID gas spouts in the posterior direction than in the anterior direction.

### Modification Examples

In the MS/MS mass spectrometer of the first and second embodiments, the configuration of the electrodes 27 and 28 respectively disposed in the dissociation area A1 and convergence area A2 is not limited to the configuration illustrated in FIG. 3, but can be modified in a variety of ways including a variety of types of conventionally known configurations. Concretely speaking, a multipole may be used such as: a quadrupole as explained in FIG. 12, and hexapole or octapole having more rod electrodes. Alternatively, a modification example as illustrated in FIGS. 5 through 10 may be used. With each of these modifications, a direct current having a potential gradient in the direction along the ion optical axis C is formed and thereby an ion can be accelerated. The configurations of FIGS. 5 through 9 are disclosed in U.S. Pat. No. 5,847,386 and other documents, and the configuration of FIG. 10 is disclosed in Japanese Patent No. 3379485 and other documents.

The configuration illustrated in FIG. 5 is composed of a main quadrupole 50 and two groups of auxiliary rod electrodes 51 and 52. Each group of the rod electrodes is composed of four auxiliary rod electrodes, and one group is placed on the entrance side of the main quadrupole 50 and the other group on the exit side. With this configuration, it is possible to form an electric field for accelerating an ion as previously described by appropriately setting each direct current voltage to be applied to the auxiliary rod electrodes 51 and 52.

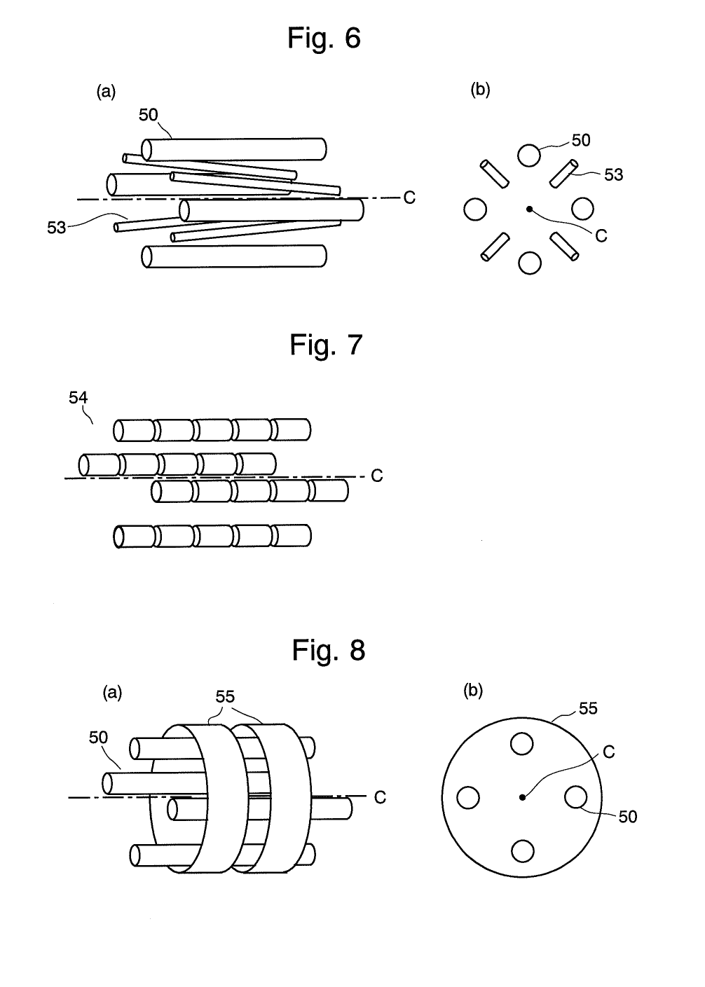

The configuration illustrated in FIG. 6 is composed of a main quadrupole 50 and a group of four auxiliary rod electrodes 53, which are not parallel to the ion optical axis C but are inclined in the ion's passage direction. With this configuration, by applying a certain direct current voltage to the auxiliary rod electrodes 53, an electric field for accelerating an ion as previously described can be formed in the vicinity of the ion optical axis C.

FIG. 7 illustrates a segmented-type quadrupole 54 in which each of the rod electrodes is segmented into a plurality of rod electrodes in the direction along the ion optical axis C. The configuration illustrated in FIG. 8 is composed of a quadrupole 50 and two-stage cylindrical electrodes 55 surrounding the quadrupole electrodes 50. By appropriately setting each of the direct current voltages applied to the two electrodes 55, an electric field for accelerating an ion as previously described can be formed.

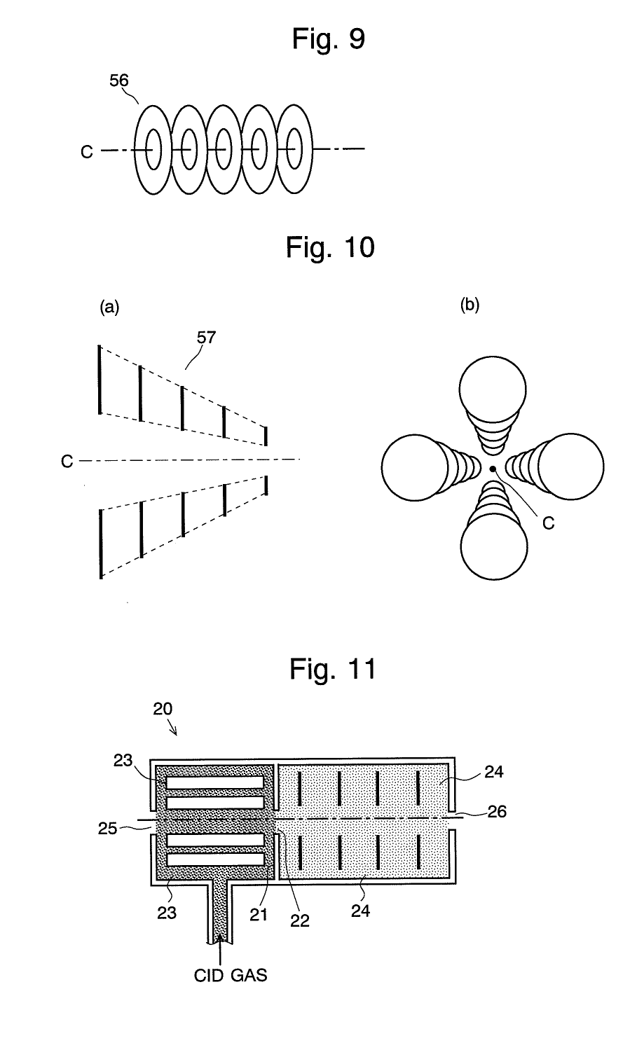

In the configuration illustrated in FIG. 9, a plurality of annular electrodes 56 are arranged along the ion optical axis C. In the configuration illustrated in FIG. 10, disk electrode plates whose diameter is sequentially decreased along the ion optical axis C are arranged in such a manner that they gradually become closer to the ion optical axis C.

Furthermore, the electrodes 27 and 28 each provided in the dissociation area A1 and the convergence area A2 are not necessarily the same among the variety of embodiments as previously described, but may be different from each other. One such example is illustrated in FIG. 11. In this example, the structure of the collision cell 20 is the same as in the first embodiment, however, an octapole in which eight rod electrodes are disposed to surround the ion optical axis C is used in the anterior chamber 23 (or dissociation area A1), and electrodes composed of disk electrode plates as in the first embodiment are provided in the posterior chamber 24 (or convergence area A2). As just described, the combination of the configurations of the electrodes 27 and 28 is arbitrary.

It should be noted that every embodiment and modification described thus far is an example of the present invention, and therefore any modification, adjustment, or addition regarding other than the aforementioned description appropriately made within the spirit of the present invention is also covered by the claims of the present patent application.

1. An MS/MS mass spectrometer in which a first mass separation unit for selecting an ion having a specific mass-to-charge ratio as a precursor ion from among a variety of ions, a dissociation/convergence unit for making the precursor ion collide with a predetermined gas provided from outside in order to dissociate the precursor ion by a collision-induced dissociation and converging ions by a cooling action due to a collision with the predetermined gas, and a second mass separation unit for selecting an ion having a specific mass-to-charge ratio from among a variety of product ions generated by a dissociation of the precursor ion, are disposed inside an analysis chamber which is vacuum-evacuated, wherein the dissociation/convergence unit independently comprises:
a dissociation area, in which a gas pressure is maintained higher than a gas pressure in the analysis chamber by the predetermined gas, for dissociating the precursor ion; and
a convergence area, in which a gas pressure is maintained higher than the gas pressure in the analysis chamber by the predetermined gas, for cooling ions sent from the dissociation area to converge the ions.

2. The MS/MS mass spectrometer according to claim 1, wherein:
an inside of a collision cell, which is substantially hermetically-closed, having an ion injection aperture and an ion exit aperture is partitioned into an anterior chamber and a posterior chamber by a partition wall having a communicating aperture;
the predetermined gas is supplied from outside into the anterior chamber or the posterior chamber; and
the dissociation area is provided in the anterior chamber and the convergence area is provided in the posterior chamber.

3. The MS/MS mass spectrometer according to claim 1, wherein an electrode to which a voltage can be independently applied is provided in the dissociation area and the convergence area.

4. The MS/MS mass spectrometer according to claim 2, wherein an electrode to which a voltage can be independently applied is provided in the dissociation area and the convergence area.

5. The MS/MS mass spectrometer according to claim 1, wherein:
the dissociation area is an inside of a collision cell having an ion injection aperture and an ion exit aperture;
the predetermined gas is supplied from outside into the collision cell; and
the convergence area is formed outside and near the ion exit aperture, in the analysis chamber.

6. The MS/MS mass spectrometer according to claim 3, wherein a kind of the electrode provided in the dissociation area and a kind of the electrode provided in the convergence are different.

7. The MS/MS mass spectrometer according to claim 4, wherein a kind of the electrode provided in the dissociation area and a kind of the electrode provided in the convergence are different.
